(19) United States
(12) Patent Application Publication
(10) Pub. No.: US 2015/0029811 A1
(43) Pub. Date: Jan. 29, 2015

(54) MIXING BLADE

(71) Applicant: KAYABA INDUSTRY CO., LTD., Minato-ku, Tokyo (JP)

(72) Inventors: Yuta Kawano, Gifu (JP); Taiji Hattori, Gifu (JP); Naoya Ishizaki, Saitama (JP); Takahiro Kobayashi, Saitama (JP); Kazunori Tanaka, Saitama (JP)

(21) Appl. No.: 14/382,760

(22) PCT Filed: Oct. 11, 2012
(86) PCT No.: PCT/JP2012/076319

§ 371 Date: Sep. 3, 2014

(30) Foreign Application Priority Data
Mar. 30, 2012 (JP) 2012-078711

(51) Int. Cl. B01F 9/08; B28C 9/04; B28C 5/42

(52) U.S. Cl. CPC B01F 9/08; B28C 5/42; B28C 9/04; B01F 2215/0047
USPC 366/66

(57) ABSTRACT

A mixing blade is formed into a spiral shape by disposing blade plates, which are twisted in a predetermined manner in a circumferential direction of the blade, adjacent to each other in the circumferential direction along an inner wall surface of a mixer drum. Each of the blade plates includes a rib extended in the circumferential direction of the blade.

### TECHNICAL FIELD

The present invention relates to a mixing blade of a mixer drum for mixing ready-mixed concrete and the like.

### BACKGROUND ART

A concrete mixer truck is a vehicle to load ready-mixed concrete in a mixer drum that is rotatably mounted on a base, and to transport it from a factory of the ready-mixed concrete to a construction site. In order to avoid quality degradation and solidification of the ready-mixed concrete, the concrete mixer truck allows the mixer drum to rotate normally to agitate the ready-mixed concrete by a spiral-shaped mixing blade provided in the mixer drum, at the time of transporting the ready-mixed concrete. Further, according to the structure of the concrete mixer truck, it is able to discharge the ready-mixed concrete in the mixer drum by rotating the mixer drum to a direction reverse to the normal rotation. When the concrete mixer truck arrives at a site to pour the concrete, it rotates the mixer drum reversely to supply the ready-mixed concrete to a pouring position.

Japanese Registered Utility Model No. 3047121 discloses a concrete mixer truck having a spiral-shaped mixing blade formed on an inner wall surface of the mixer drum.

### SUMMARY OF INVENTION

The mixing blade of the above-described concrete mixer truck is formed by spirally disposing a plurality of blade plates that are twisted in a predetermined manner in a circumferential direction of the blade, adjacent to each other along the inner wall surface of the mixer drum. When disposing the blade plates in the mixer drum, it is important to connect the adjacent blade plates by allowing edges of the blade plates adjacent in the circumferential direction of the blade to connect each other, so as not to cause a difference in level between the adjacent blade plates due to clearance and displacement.

However, as torsion processing and bending processing are applied to the blade plates, variations in form accuracy may be caused due to springback and the like. When the form accuracy of the respective blade plates varies, the displacement is caused in abutting surfaces of the abutting edges of the adjacent blade plates. Thus, it is necessary to set the blade plates in the mixer drum while correcting the displacement.

It is an object of the present invention to provide the mixing blade formed by the blade plates with high form accuracy.

According to an aspect of the present invention, a mixing blade is provided. The mixing blade is formed into a spiral shape by disposing blade plates, which are twisted in a predetermined manner in a circumferential direction of the blade, adjacent to each other in the circumferential direction along an inner wall surface of a mixer drum. Each of the blade plates includes a rib extended in the circumferential direction of the blade.

The details as well as other features and advantages of this invention are set forth in the remainder of the specification and are shown in the accompanying drawings.

### BRIEF DESCRIPTION OF DRAWINGS

FIG. 1 is a side view of a concrete mixer truck having a mixing blade according to an embodiment of the present invention.

FIG. 2 is a rear view of a mixer drum mounted on a base of the concrete mixer truck.

FIG. 3 is a perspective view of the mixer drum of the concrete mixer truck.

FIG. 4 is a view showing the mixing blade viewed from the front side in an axial direction of the mixer drum.

FIG. 5 is a perspective view of the mixing blade.

FIG. 6 is a front view of a blade plate constituting the mixing blade.

FIG. 7 is a vertical sectional view of the blade plate.

FIG. 8 is a partial vertical sectional view at the position where a rib is formed on the blade plate.

FIG. 9 is a front view of a blade plate according to a modification example of the embodiment of the present invention.

### DESCRIPTION OF EMBODIMENTS

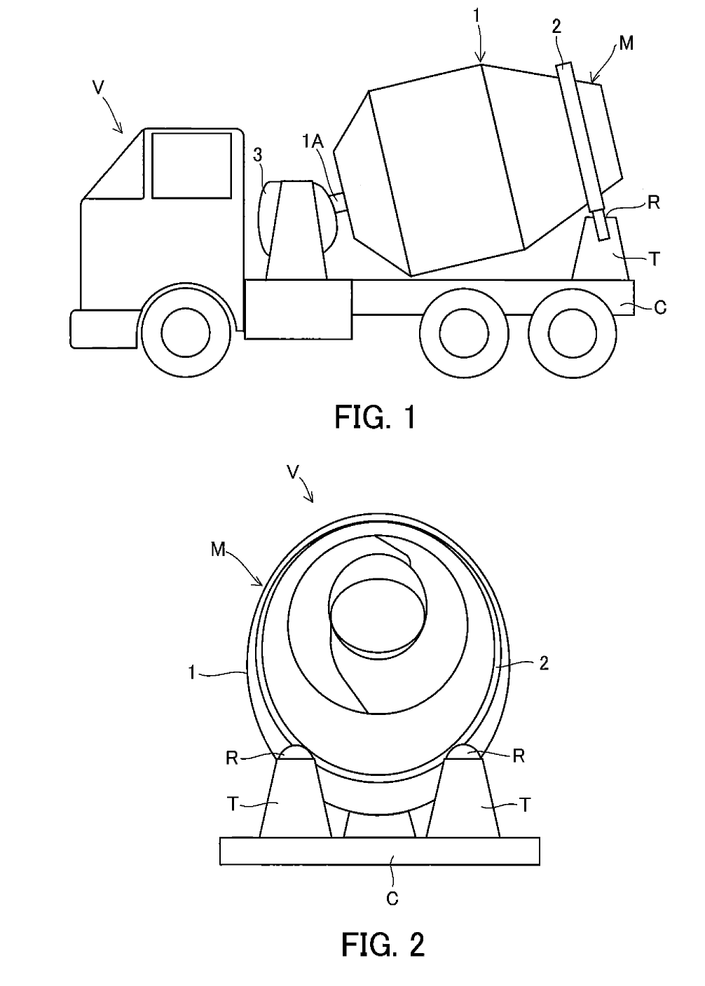

FIG. 1 is a side view of a concrete mixer truck having a mixing blade according to an embodiment of the present invention. FIG. 2 is a rear view of a mixer drum mounted on a base of the concrete mixer truck.

A concrete mixer truck V as shown in FIG. 1 is a vehicle to transport ready-mixed concrete that is charged into a mixer drum M at a concrete plant to a pouring site. According to the structure of the concrete mixer truck, the ready-mixed concrete is discharged at the pouring site, and thereafter, wash water is charged into the mixer drum M to clean the inside of the mixer drum M.

As shown in FIG. 1 and FIG. 2, the mixer drum M is mounted on a base C of the concrete mixer truck V. At the back of the base C of the concrete mixer truck V, a pair of brackets T are provided with a predetermined interval therebetween in a vehicle width direction, and rollers R are rotatably provided at the upper ends of the brackets T. The mixer drum M is formed by a drum shell 1 that has a bottomed cylindrical shape with its back end being opened. A shaft 1A is provided at the front end of the drum shell 1 of the mixer drum M, and a roller ring 2 is provided at the outer periphery of the back of the drum shell 1. The roller ring 2 of the mixer drum M is supported by the pair of the rollers R located at the backside of the base C, and the shaft 1A of the mixer drum M is connected to a hydraulic motor 3 located at the front side of the base C. Thus, the mixer drum M is rotatably attached onto the base C while it is leaning forward with its back end side being lifted upward.

As pressure oil is supplied from a hydraulic pump that is driven based on engine power of the concrete mixer truck V, the hydraulic motor 3 rotates normally or reversely to drive the mixer drum M. A speed reducer may be interposed between the hydraulic motor 3 and the mixer drum M.

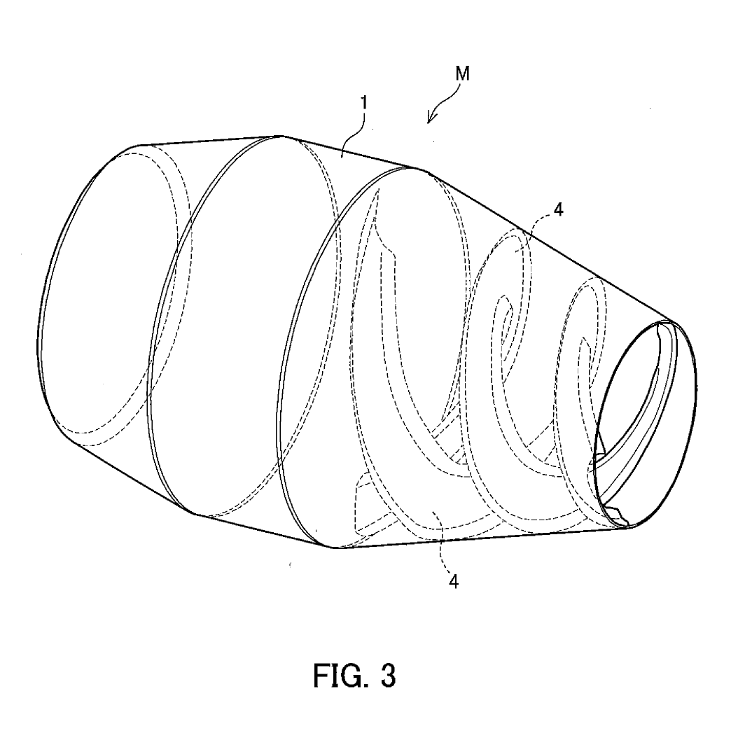

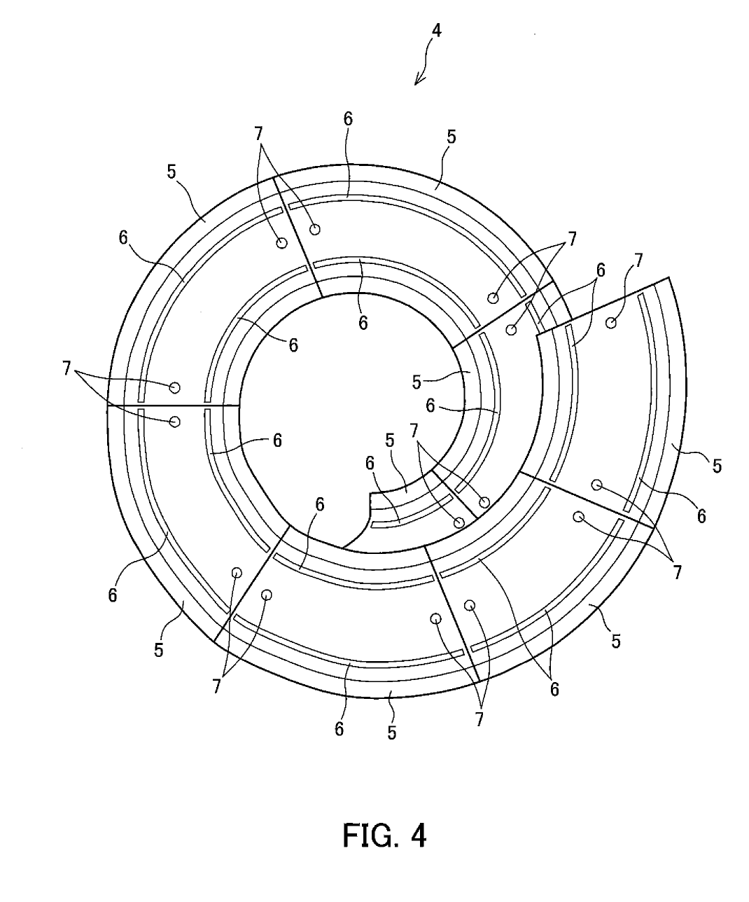

As shown in FIG. 3, mixing blades 4 are provided in the mixer drum M (drum shell 1). The mixing blades 4 are disposed spirally along an inner wall surface of the mixer drum M. A pair of the mixing blades 4 are provided in the mixer drum M, and the mixing blades 4 are located to have a phase difference of 180° with respect to a rotation center. It should be noted that, even though only the mixing blades 4 at the backside of the mixer drum M are illustrated in FIG. 3, the mixing blades 4 are provided from the front to the back of the mixer drum M in actuality.

When charging and agitating the ready-mixed concrete, the mixer drum M is driven to rotate normally by the hydraulic motor 3. When the mixer drum M is thus rotated normally, the loaded ready-mixed concrete is sent from the back to the front of the mixer drum M by the mixing blades 4 rotating with the mixer drum M. This allows the ready-mixed concrete to be charged and agitated. When charging the ready-mixed concrete into the mixer drum M, the mixer drum M is rotated normally at 10 rpm, for example, by the hydraulic motor 3. Whereas, when discharging the ready-mixed concrete, the mixer drum M is driven to rotate reversely at 10 rpm, for example, by the hydraulic motor 3. When the mixer drum M is rotated reversely like this, the ready-mixed concrete is sent from the front to the back of the mixer drum M by the mixing blades 4 rotating with the mixer drum M. This allows the ready-mixed concrete to be discharged from the opening end of the mixer drum M.

As described above, the mixer drum M is rotatably driven according to three modes, that is, a charging mode used when charging the ready-mixed concrete, an agitating mode used when agitating the ready-mixed concrete, and a discharging mode used when discharging the ready-mixed concrete. In the agitating mode, the mixer drum M is driven to rotate normally at a slow speed of, for example, 0.8 to 2 rpm, in order to prevent solidification of the ready-mixed concrete and an increase in its slump value.

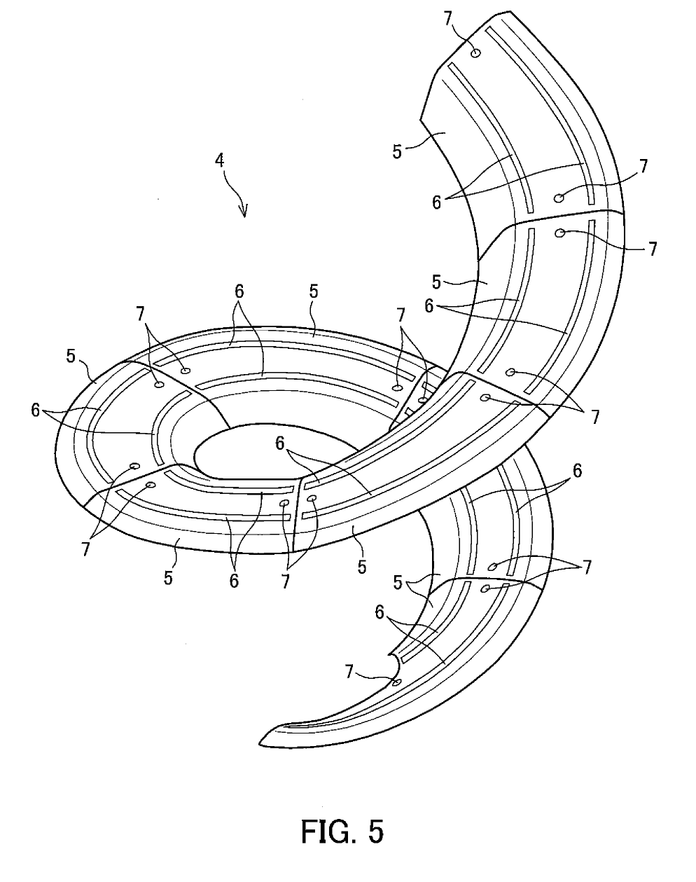

Next, the structure of the mixing blade 4 will be explained with reference to FIG. 4 and FIG. 5. FIG. 4 is a view showing the mixing blade viewed from the front side in an axial direction of the mixer drum M. FIG. 5 is a perspective view of the mixing blade. In FIG. 5, the front side in the axial direction of the mixer drum M is shown in the upper side of the drawing, and the backside in the axial direction of the mixer drum M is shown in the lower side of the drawing.

As shown in FIG. 4 and FIG. 5, the mixing blade 4 is formed by a plurality of blade plates 5 arranged in a circumferential direction (longitudinal direction) of the blade plates 5. The mixing blade 4 is fixed to the inside of the mixer drum M with its outer edge being welded to the inner wall surface of the mixer drum M.

Each of the blade plates 5 constituting the mixing blade 4 is a fan-shaped plate member, and is subjected to torsion processing to be twisted in the circumferential direction of the blade. Thus-formed blade plates 5 are arranged along the inner wall surface of the mixer drum M, so that the mixing blade 4 as a whole has a spiral shape. When assembling the mixing blade 4, edges of the two blade plates 5 that are adjacent to each other in the circumferential direction of the blade are connected, and the edges are bonded to each other by welding and the like.

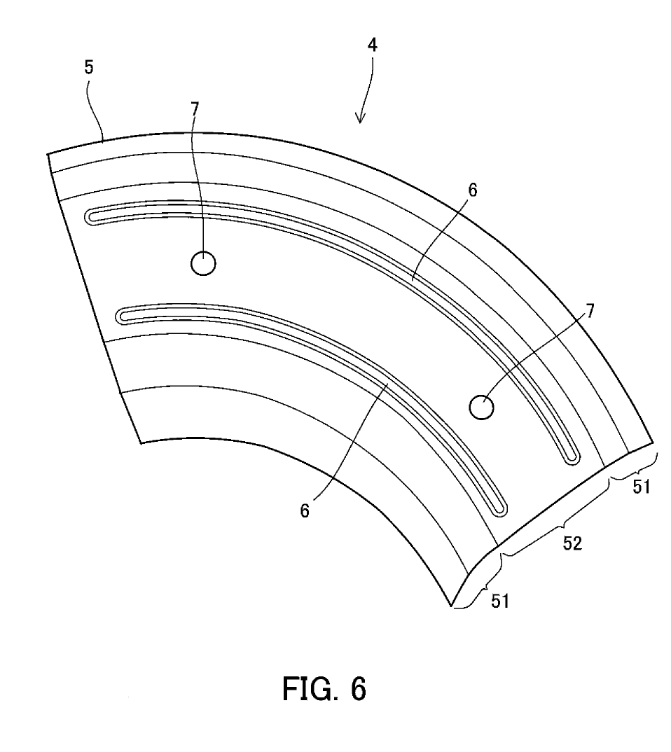

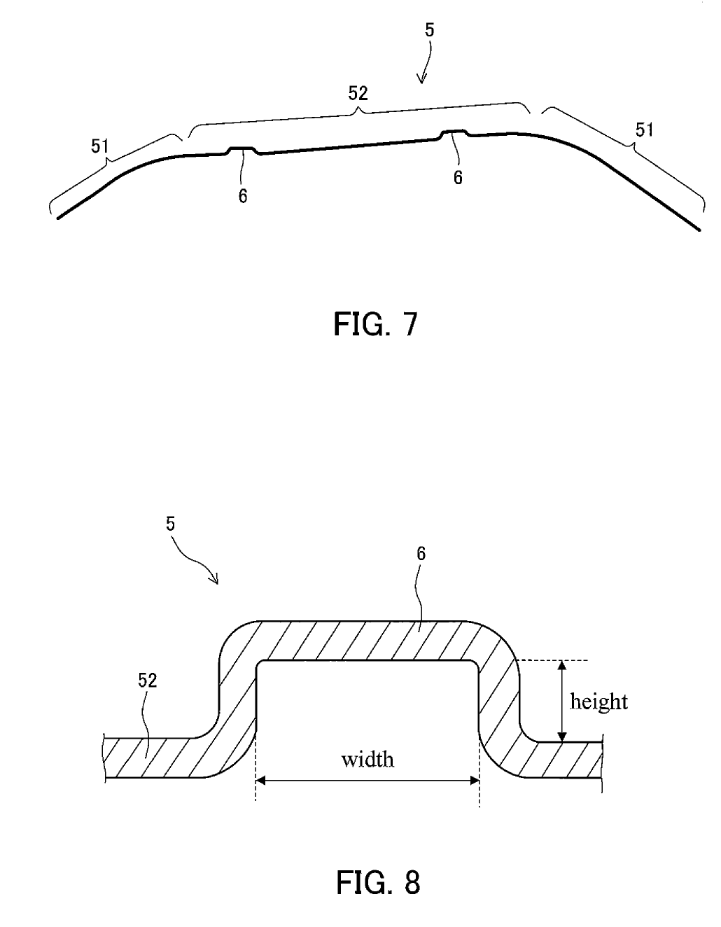

Next, the structure of the blade plate 5 in the mixing blade 4 will be explained with reference to FIG. 6 to FIG. 8. FIG. 6 is a front view of the blade plate 5 constituting the mixing blade 4. FIG. 7 is a vertical sectional view of the blade plate 5. FIG. 8 is a partial vertical sectional view at the position where a rib is formed on the blade plate 5.

As shown in FIG. 6 and FIG. 7, the blade plate 5 is an arc-shaped plate member, and is subjected to the torsion processing to be twisted in the circumferential direction of the blade (longitudinal direction) of the blade plate 5. In the blade plate 5, edge areas 51 in a radial direction that is perpendicular to the circumferential direction of the blade are formed to curve. The blade plate 5 has a central area 52 between the edge area 51 on the side of the outside diameter and the edge area 51 on the side of the inside diameter. The central area 52 located between the both edge areas 51 is formed to have a curved surface that is gentler than those of the edge areas 51.

The blade plate 5 is formed by presswork of a flat plate member using upper and lower shaping dies. The edge areas 51 and the central area 52 of the blade plate 5 are subjected to bending processing by the upper and lower shaping dies, and the entire blade plate 5 is subjected to the torsion processing in the circumferential direction.

Incidentally, with the plate member to which the bending processing or the torsion processing is applied, springback, caused after being formed, usually reduces a bending deformation amount or a torsional deformation amount, which results in a reduction in form accuracy. In order to prevent the reduction in the form accuracy, the forming may be made by using the shaping dies which are die-sunk in consideration of the above-described springback. However, an amount of recovery due to the springback varies according to the extent of the bending and the torsion of the plate member and the direction (metal rolling direction) to obtain a plate member material, which makes it difficult to realize the desired form accuracy.

Therefore, the blade plate 5 of the mixing blade 4 according to this embodiment has lateral ribs 6 formed thereon for controlling the springback, as shown in FIG. 6 and FIG. 7.

Each of the ribs 6 is projectingly formed on the front surface of the blade plate 5, and is a projection in the circumferential direction that is extended in an arc shape along the circumferential direction of the blade. A pair of the ribs 6 are formed in the central area 52 of the blade plate 5. One of the ribs 6 is located at the position near the edge area 51 on one side, and the other of the ribs 6 is located at the position near the edge area 51 on the other side. Each rib 6 is formed by making a recess in the back surface of the blade plate 5 that is curved in a concave manner, and making a projection on the front surface of the blade plate 5 that is curved in a convex manner.

As shown in FIG. 8, the height of the rib 6 is set to be equal to or higher than the plate thickness of the blade plate 5, and the width of the rib 6 is set to be equal to or wider than the plate thickness of the blade plate 5.

The above-described shaping dies for forming the blade plate 5 include an upper die and a lower die. Arc-shaped recesses for forming the ribs 6 are concavely formed in the lower die of the shaping dies, and arc-shaped projecting strips for forming the ribs 6 are projectingly formed on the upper die of the shaping dies at the positions corresponding to the recesses in the lower die.

As shown in FIG. 6, the blade plate 5 includes two positioning holes 7 that are able to engage with two positioning pins provided on the shaping die. The positioning pins are projectingly formed on the lower die of the shaping dies, and the positioning holes 7 of the plate member, before being press-formed, are engaged with the positioning pins, so that the plate member is positioned with respect to the shaping dies with high accuracy. It should be noted that holes are formed in the upper die of the shaping dies in order to receive the positioning pins at the time of press-forming.

It is desirable that an interval between the two positioning holes 7 is made as large as possible in order to improve positioning accuracy of the plate member. For this purpose, one of the positioning holes 7 is provided at the position near one edge of the blade plate 5 in the circumferential direction, and the other of the positioning holes 7 is provided at the position near the other edge of the blade plate 5 in the circumferential direction. These positioning holes 7 are formed in the central area 52 with a relatively small deformation margin, not in the edge areas 51 to which a greater extent of the bending processing is applied when being formed.

The plate member is subjected to the presswork by the shaping dies to form the blade plate 5. The arc-shaped ribs 6 are formed in the central area 52 of the blade plate 5. The ribs 6 increase rigidity in a torsional direction, and prevent the torsional deformation applied to the blade plate 5 from being recovered due to the springback. This makes it possible to improve the form accuracy of the blade plate 5 after being formed.

Thus, when the blade plates 5 are set in the mixer drum M, it is possible to suppress displacement of the blade plates 5 in the torsional direction between abutting edges of the adjacent blade plates 5, so that bonding properties of the blade plates 5 can be improved, and the blade plates 5 can be connected smoothly. This allows the blade surface of the mixing blade 4, formed by the plurality of the blade plates 5, to be a continuous surface with little difference in level.

As each blade plate 5 includes the positioning holes 7 that are able to engage with the positioning pins provided on the shaping die, the positioning pins of the shaping die are engaged with the positioning holes 7, so that the plate member before being formed into the blade plate 5 can be positioned with respect to the shaping dies. This makes it possible to further improve the form accuracy of the blade plate 5 after the forming processing.

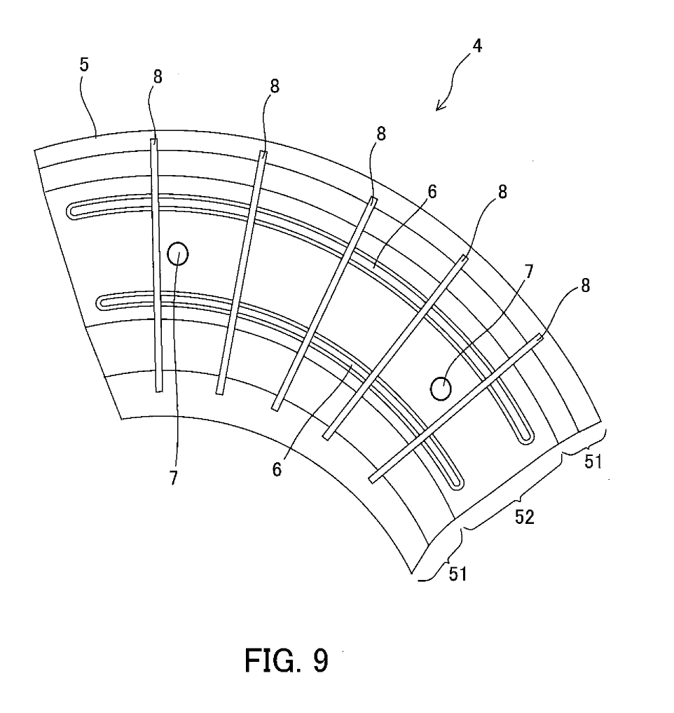

Next, a modification example of this embodiment will be explained with reference to FIG. 9. FIG. 9 is a front view of the blade plate 5 of the mixing blade 4 according to the modification example.

As shown in FIG. 9, the blade plate 5 of the mixing blade 4 according to the modification example includes not only the ribs 6, but also longitudinal ribs 8. The longitudinal ribs 8 are projections in the radial direction that are projectingly formed on the front surface of the blade plate 5, and are linearly extended in the radial direction of the blade. A plurality of the longitudinal ribs 8 are provided and disposed in the circumferential direction of the blade plate 5 with equal intervals therebetween. Each of the longitudinal rib 8 is formed by making a recess in the back surface side of the blade plate 5, and making a projection on the front surface side of the blade plate 5. The longitudinal rib 8 extended across the central area 52 to the positions just before an inner circumferential edge and an outer circumferential edge of the edge areas 51.

The height of the longitudinal rib 8 may be equal to or higher than the plate thickness of the blade plate 5, and the width of the longitudinal rib 8 may be equal to or wider than the thickness of the blade plate 5.

Incidentally, linear recesses for forming the longitudinal ribs 8 are concavely formed in the lower die of the shaping dies for forming the blade plate 5, and linear projecting strips for forming the longitudinal ribs 8 are projectingly formed on the upper die of the shaping dies at the positions corresponding to the recesses in the lower die.

The longitudinal ribs 8 increase bending rigidity in the radial direction of the blade plate 5, and prevent bending deformation that is applied to the blade plate 5 from being recovered due to the springback. This makes it possible to improve the form accuracy of the blade plate 5 after being formed.

Thus, when the blade plates 5 are set in the mixer drum M, it is possible to suppress the displacement of the blade plates 5 in the radial direction between the abutting edges of the adjacent blade plates 5, so that the bonding properties of the blade plates 5 can be improved, and the blade plates 5 can be connected smoothly. This allows the blade surface of the mixing blade 4, formed by the plurality of blade plates 5, to be the continuous surface with little difference in level.

The above-described mixing blade 4 is formed into the spiral shape by disposing the blade plates 5 that are twisted in a predetermined manner in the circumferential direction of the blade (longitudinal direction) adjacent to each other along the inner wall surface of the mixer drum M. Each of the blade plates 5 constituting the mixing blade 4 includes the ribs 6 that are extended along the circumferential direction of the blade, which makes it possible to fix (normalize) the torsional deformation applied to the blade plate 5, and to suppress the springback in the torsional direction. Thus, the form accuracy of the blade plates 5 can be improved, and the bonding properties between the blade plates 5 that are arranged adjacent to each other in the circumferential direction can be improved. Note that, it is preferable to set the height and the width of each of the ribs 6 to be equal to or larger than the plate thickness of the blade plate 5, in order to suppress the springback of the blade plates 5 more securely.

In this blade plate 5, the edge areas 51 are formed to curve, and the central area 52 is formed to have the curve that is gentler than those of the edge areas 51. The ribs 6 are provided at the positions adjacent to the edge areas 51 in the central area 52. Namely, the ribs 6 to suppress the springback are arranged in the central area 52 with the relatively small deformation margin at the time of press-forming processing, so that the form accuracy of the blade plate 5 in the circumferential direction can be further improved.

With the mixing blade 4 according to the modification example, the blade plate 5 includes the longitudinal ribs 8 that extend linearly in the radial direction of the blade. The longitudinal ribs 8 can fix (normalize) the bending deformation applied to the blade plate 5, and suppress the springback of the bending deformation in the radial direction applied at the time of press-forming processing.

The blade plate 5 includes the positioning holes 7 that engage with the positioning pins of the shaping die, in the central area 52 in the circumferential direction of the blade. This allows the plate member as the material to be positioned with respect to the shaping dies with high accuracy at the time of press-forming processing, and the form accuracy to be improved after the forming processing.

Although the invention has been described above with reference to certain embodiments, the invention is not limited to the embodiments described above. Modifications and variations of the embodiments described above will occur to those skilled in the art, within the scope of the claims.

This application claims priority based on Japanese Patent Application No. 2012-78711 filed with Japan Patent Office on Mar. 30, 2012, the entire contents of which are incorporated into this specification by reference.

1. A mixing blade formed into a spiral shape by disposing blade plates, which are twisted in a predetermined manner in a circumferential direction of the blade, adjacent to each other in the circumferential direction along an inner wall surface of a mixer drum,
wherein each of the blade plates comprises a rib extended in the circumferential direction of the blade.

2. The mixing blade as defined in claim 1, wherein the rib is formed by making a recess in a back surface side of the blade plate and making a projection on a front surface side of the blade plate.

3. The mixing blade as defined in claim 1, wherein the blade plate further comprises positioning holes engaging with positioning pins of a shaping die in press-forming processing, at both ends in the circumferential direction of the blade.

4. The mixing blade as defined in claim 1, wherein the blade plate further comprises a longitudinal rib extended in a radial direction that is perpendicular to the circumferential direction of the blade.

5. The mixing blade as defined in claim 1,
wherein the blade plate has edge areas formed to curve in a radial direction that is perpendicular to the circumferential direction of the blade, and
wherein the rib is provided at a position near the edge area in a central area located between the edge areas that are on an outer side and an inner side in the radial direction.

6. The mixing blade as defined in claim 1, wherein the rib is formed to have a height equal to or higher than a thickness of the blade plate and have a width equal to or wider than the thickness of the blade plate.

7. The mixing blade as defined in claim 4, wherein the longitudinal rib is formed to have a height equal to or higher than a thickness of the blade plate and have a width equal to or wider than the thickness of the blade plate.
